(19) United States
(12) Patent Application Publication
(10) Pub. No.: US 2006/0070805 A1
(43) Pub. Date: Apr. 6, 2006

(54) WALL-MAT

(76) Inventors: Daniel Lester Bailey, Orange, TX (US); Robert Campbell JR., Houston, TX (US)

Correspondence Address: Daniel Lester Bailey, 4519 Geneva Drive, Houston, TX, 77066, US

(21) Appl. No.: 10/856,787

(22) Filed: Sep. 17, 2004

(51) Int. Cl. E06C 5/32

(52) U.S. Cl. 182/129

(57) ABSTRACT

This invention is a singular unit, designed to work with almost any extension ladder, for the purpose of protecting the surface upon which the ladder is employed form dents, scratches, or marks caused by the bare ends of the ladder rails. It consists of a solid base plate of approximately twelve inches by eighteen inches, on one side of which is fastened by means of adhesive a foam rubber cushion. On the opposite side of which at each end is a means of attaching a nylon strap. These are used opposing each other to attach the unit to the ladder at the top or directly above any rung on the ladder, thereby securing the unit and yet allowing enough flexibility so that the unit will seek its own level against the surface upon which it is employed.

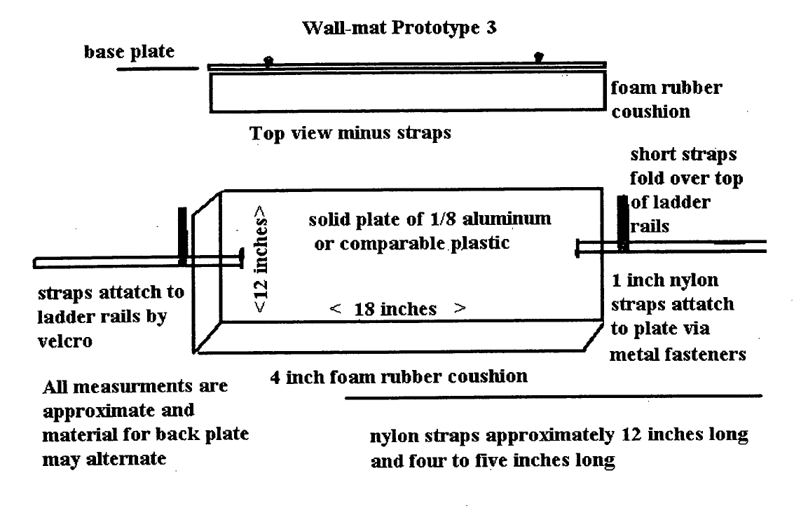

### DETAILED DESCRIPTION

Our invention is specifically designed to for use with almost any extension ladder to protect any surface upon which the ladder may be positioned with over two hundred square inches of cushioned surface which will actually conform to the surface the extension ladder is employed against, not only protecting the surface, but creating a bond with that surface which makes the ladder far less likely to slip than with the ladder rails alone.

This invention consists of a solid base plate of approximately twelve inches by eighteen inches made of aluminum or a comparably strong and rigid material, on one side of which is secured by means of adhesive a foam rubber cushion of the same dimensions and approximately four inches thick. On the opposite side at each end the plate has, drilled in it two holes of one quarter of one inch in diameter to accept a piece of aluminum rod which is bent in a semi rectangular shape to protrude through the plate and be bradded on the bottom end. Each of these form a receptacle for receiving the nylon straps that hold the unit in place at the top of or directly above any rung on the extension ladder. The nylon straps may vary in length from twelve to eighteen inches. Depending on the ladder that the unit is used with the user may cut them or leave the ends hanging. The straps work opposing each other so that the unit is kept from moving either direction as well being secured to the ladder and are fitted with nylon buckles with which to pull down and anchor the unit in place. When used properly the nylon straps not only secure the unit in place but also allow enough flexibility that the unit will seek it's own level against the surface upon which the ladder is employed.

1. What we claim as our invention is a singular unit composed of a base plate of approximately twelve inches by eighteen inches, on one side of which is secured by means of adhesive a foam rubber cushion of the same dimensions approximately four inches thick. On the opposite side of which, at each end is a means of attaching a nylon strap, for the purpose of securing the unit to the end or directly above any rung on an extension ladder.

2. What is claimed, as in claim #1 is a base plate of approximately twelve inches by eighteen inches. Said base plate is made of aluminum or a comparably strong and rigid material, such as plastic, a composite, etc.

3. We claim that our invention is different from any existing invention in the same category in that THE WALL-MAT covers over two hundred square inches thereby dispersing the weight of both the ladder and it's occupant to drastically reduce the weight per square inch exerted upon any surface that the ladder may be employed against.

4. We claim that the two nylon straps mentioned in claim #1 with which THE WALL-MAT is secured to the extension ladder not only hold the unit in place, but also allows enough flexibility so that the unit will seek its own level against the surface upon which it is employed simply by moving the bottom of the ladder slightly away from said surface after the unit is in place.
